(19) United States
(12) Patent Application Publication
(10) Pub. No.: US 2009/0132697 A1
(43) Pub. Date: May 21, 2009

(54) INTEGRATION OF PASSENGER AND FLIGHT OPERATION COMMUNICATIONS

(76) Inventors: Paul Raymond Scheid, West Hartford, CT (US); William H. Beacham, Enfield, CT (US)

Correspondence Address: CARLSON, GASKEY & OLDS/PRATT & WHITNEY, 400 WEST MAPLE ROAD, SUITE 350, BIRMINGHAM, MI, 48009, US

(21) Appl. No.: 12/062,676

(22) Filed: Apr. 4, 2008

(51) Int. Cl. G06F 15/173

(52) U.S. Cl. 709/224

(57) ABSTRACT

A communications device is provided for permitting internet access on an aircraft. A first computer on the aircraft is in communication with the communications device. A second computer on the aircraft is also in communication with the same communications device. Access to the first computer is provided to a passenger. Access to the second computer is provided to a second person. The passenger is prevented from obtaining access to the second computer.

### BACKGROUND OF THE INVENTION

This invention relates to a method for aircraft communication.

An aircraft may have a computer that monitors operations of the aircraft. Specifically, the computer may track information relating to particular components of the aircraft, its systems and flight information. This information may be relayed to an airline or a maintenance facility on the ground during flight. In this way, the facility can anticipate repairs, obtain information relating to operation of the aircraft, and make adjustments to the aircraft.

Currently, existing systems for communicating operational information to the ground are very slow and expensive. Given the large amount of information gathered by the computer, there is a need for a fast and inexpensive way for communicating operational information from the aircraft in the air to the airline and/or maintenance facility on the ground.

### SUMMARY OF THE INVENTION

A method of aircraft communication involves providing a communication device that permits internet access on an aircraft. A first computer on the aircraft is in connection with the communications device. A second computer on the aircraft stores information relating to the operation of the aircraft and is also in communication with the communications device. Access is provided to the first computer for a passenger. Access is provided to the second computer for a second person. The passenger is prevented from obtaining access to the second computer.

The various features and advantages of this invention will become apparent to those skilled in the art from the following detailed description. The drawings that accompany the detailed description can be briefly described as follows.

### BRIEF DESCRIPTION OF THE DRAWINGS

FIG. 1 illustrates a system for aircraft maintenance.

FIG. 2 illustrates a technique for aircraft maintenance.

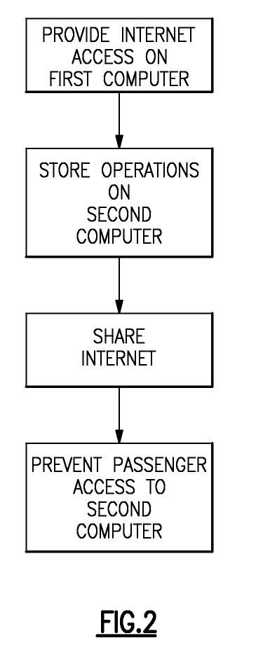

### DETAILED DESCRIPTION OF THE PREFERRED EMBODIMENT

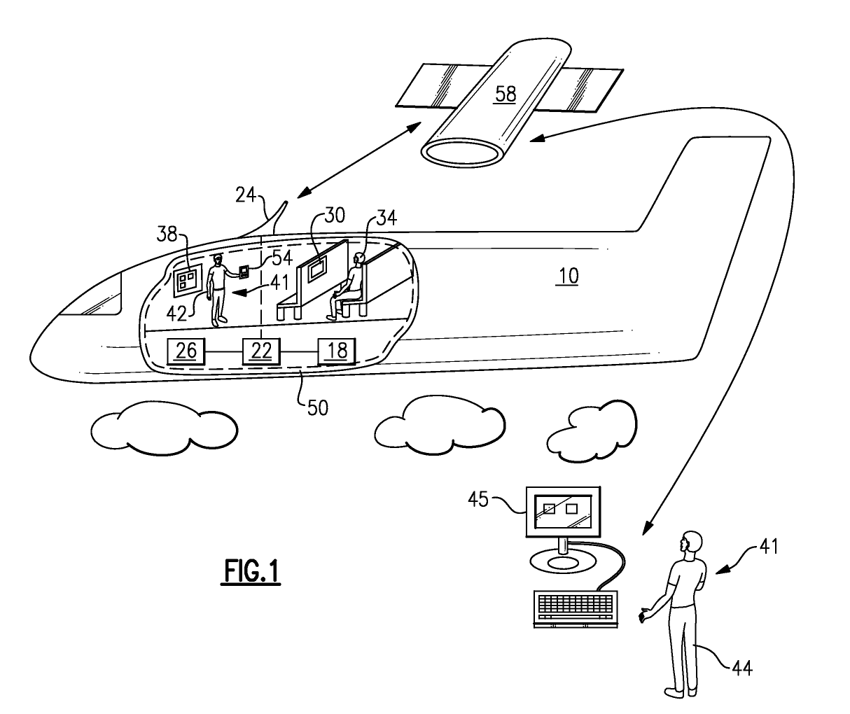

With reference to FIG. 1, there is shown aircraft 10, which is shown in flight. On aircraft 10, there is first computer 18 and second computer 26. First computer 18 is in communication with communications device 22, such as a wireless router (for example, an 802.11 connectivity standard router) and a broadband modem connected to antenna 24. First computer 26 acts as a client to the internet. Through communications device 22, first computer 18 is used to provide high speed internet access to first person 34, say a passenger on aircraft 10, through satellite 58 or cell tower (not shown). Also through communications device 22, first computer 18 creates wireless local area network 50 for communication with first computing device 30, such as a display in the head rest of a seat, a personal digital assistant of a passenger, a passenger owned computer, or a passenger cell phone. In this way, first person 34 may obtain access to the internet through first computing device 30 via first computer 18, which acts as a server for computing device 30.

Also on aircraft 10 is second computer 26. Second computer 26 stores and processes information relating to operation of aircraft 10, such as information relating to an aircraft component, an aircraft system or aircraft flight information. Through wireless local area network 50, second computer 26 communicates with first computer 18, which acts as a server for second computer 26 for high speed internet access through communications device 22. Second computer 26 is thereby linked with communications device 22 to obtain broadband access to the internet. Accordingly, information relating to operation of aircraft 10 can be communicated quickly across the internet via communications device 22. This information can be communicated to second person 41, who may be crew member 42 on aircraft 10 or be maintenance technician 44 on the ground.

Due to the sensitive nature of information on second computer 26, first person 34, the passenger or any other unauthorized person, is blocked from obtaining access to second computer 26 through a security feature, such as requiring a security code prior to granting access to second computer 36. In this way, first computer 18 and second computer 26 can share internet access through communications device 22 without compromising the security of second computer 26. A single communications device 22 may accordingly provide high speed internet access to crew member or maintenance technician and to passenger.

On aircraft 10 information relating to operation of aircraft 10 can be communicated directly to crew member 42 by second computer 26 or through the internet via wireless local area network 50. For example, crew member 42 may have computing device 54 to obtain access to information relating to operation of aircraft 10 once the security code is entered. Accordingly, second person 41 has access to information on second computer 26, which prevents access to the same information by first person 34.

Information relating to operation of aircraft 10 is also communicated by satellite 58 to computer 45 at the airline or maintenance facility. The information can be communicated to computer 45 directly or through the internet. On the ground, maintenance technician 44 can obtain access information relating to operation of aircraft 10 on second computer 26 with entry of the security code. Because this information is passed through high speed internet access through communications device 22, maintenance technician 44 can obtain this information quickly.

In this way, second computer 26 containing operational information of aircraft 10 may share communications device 22 with first computer 18 without permitting access to second computer by first person 34. By sharing access to communication device 22, second computer 26 obtains the benefit of broadband speed transmission of information to second person 42, such as maintenance technician 44, without the added cost of a separate broadband connection.

The foregoing description shall be interpreted as illustrative and not in any limiting sense. A worker of ordinary skill in the art would recognize that certain modifications would come within the scope of this invention. For that reason, the follow claims should be studied to determine the true scope and content of this invention.

We claim:

1. A method of aircraft communication, comprising the steps of:
(a) providing a communications device for permitting internet access on an aircraft;
(b) providing a first computer on the aircraft in communication with the communications device;
(c) providing a second computer on the aircraft, the second computer in communication with the communications device and storing information relating to the operation of the aircraft;
(d) providing access to the first computer for a passenger;
(e) providing access to the second computer for a second person different from the passenger; and
(f) preventing the passenger from obtaining access to the second computer.

2. The method of claim 1 wherein the internet access is broadband.

3. The method of claim 1 wherein the second person is on the aircraft.

4. The method of claim 1 wherein the second person is remote from the aircraft.

5. The method of claim 1 wherein preventing the passenger from obtaining access to the second computer comprises requiring authorization to obtain access to the second computer.

6. The method of claim 1 wherein at least one of the first computer and the second computer serves as a client to the internet.

7. The method of claim 1 including the step of:
(g) creating a wireless local area network through at least one of the first computer and the second computer.

8. The method of claim 7 wherein the first computer communicates to the second computer through the wireless local area network.

9. The method of claim 8 including a computing device in communication with at least one of the first computer and the second computer through the wireless local area network.

10. The method of claim 1 wherein information relating to the operation of the aircraft relates to at least one of an aircraft component, aircraft system, and aircraft flight information.

11. A method of aircraft communication, comprising the steps of:
(a) providing a communications device for permitting internet access on an aircraft;
(b) providing a first computer on the aircraft in communication with the communications device;
(c) providing a second computer on the aircraft, the second computer in communication with the communications device and storing information relating to operation of at least one of an aircraft component, aircraft system, and aircraft flight information, wherein at least one of the first computer and the second computer serves as a client to the internet through the communications device.
(d) providing access to the first computer for a passenger;
(e) providing access to the second computer for a second person; and
(f) preventing the passenger from obtaining access to the second computer.

12. The method of claim 11 wherein the internet access is broadband.

13. The method of claim 11 wherein the second person is on the aircraft.

14. The method of claim 11 wherein the second person is remote from the aircraft.

15. The method of claim 11 wherein preventing the passenger from obtaining access to the second computer comprises requiring authorization to obtain access to the second computer.

16. The method of claim 11 including the step of:
(g) creating a wireless local area network through at least one of the first computer and the second computer.

17. The method of claim 16 wherein the first computer communicates to the second computer through the wireless local area network.

18. The method of claim 17 including a computing device in communication with at least one of the first computer and the second computer through the wireless local area network.

19. A system for aircraft communication, comprising the steps of:
a communications device for permitting internet access on an aircraft;
a first computer on the aircraft in communication with said communications device;
a second computer on the aircraft, said second computer in communication with the communications device and storing information relating to the operation of the aircraft; and
a security feature on at least one of said first computer and said second computer preventing a passenger from obtaining access to said second computer.

20. The system of claim 1 wherein information relating to the operation of the aircraft comprises information relating to at least one of an aircraft component, an aircraft system and aircraft flight information.
